(19) United States
(12) Patent Application Publication
(10) Pub. No.: US 2010/0140541 A1
(43) Pub. Date: Jun. 10, 2010

(54) PREPARATION OF FUNCTIONALIZED, IN PARTICULAR ALKENYLATED, ORGANOMONOALKOXY-(OR MONOHYDROXY)-SILANES

(76) Inventors: Gérard Mignani, Lyon (FR); Samir Mansouri, Valencin (FR); Samuel Arthaud, Mornant (FR); Thierry Vidal, Lyon (FR)

Correspondence Address: BUCHANAN, INGERSOLL & ROONEY PC, POST OFFICE BOX 1404, ALEXANDRIA, VA, 22313-1404, US

(21) Appl. No.: 12/514,251

(22) PCT Filed: Nov. 9, 2007
(86) PCT No.: PCT/EP2007/062163

§ 371 Date: Dec. 23, 2009

(30) Foreign Application Priority Data
Nov. 10, 2006 (FR) 06 09839

(51) Int. Cl. C09K 3/00; C07F 7/08

(52) U.S. Cl. 252/182.3; 556/478

(57) ABSTRACT

Functionalized organomonoalkoxy (or monohydroxy) silanes, in particular alkenyl (allyl) functionalized silanes, are useful as intermediates in organic synthesis, and are prepared by reacting dialkyldialkoxysilanes with an organic halide compound (allyl halide) (III) in an ether solvent (SI), such compound (III) being suited to substitute the alkoxy groups by functionalized groups, for example alkenyl groups.

The present invention relates to a novel route for synthesizing functionalized, and in particular unsaturated (for example alkenylated), organomonoalkoxy-(or monohydroxy)-silanes, which may be used especially as synthetic intermediates in organic chemistry, for the production of organomonoalkoxy-(or monohydroxy)-silanes functionalized with groups other than alkenyls, for example with amine, thiol or polysulfide groups.

The invention is also directed toward compositions containing such synthetic intermediates in organic chemistry.

The technical problem underlying the invention is that of finding an alternative to the known techniques for synthesizing functionalized organomonoalkoxy-(or monohydroxy)-silanes, which can allow their improvement, for example with regard to the yield, the production efficiency, the cost and the environmental friendliness.

Patent application JP-A-2002179687 describes a process for manufacturing halogenated organoalkoxysilanes, comprising steps (i) to (iii) below:
(i) reacting a tetraalkoxysilane [Si(OCH₃)₄] or a trialkoxysilane with a halogenated organomagnesium compound [for example (C₅H₄)— MgCl or (C₆H₅)—MgCl] dissolved in an ether solvent such as tetrahydrofuran (THF); this reaction takes place in a nonpolar solvent (for example xylene) with a boiling point higher than that of the ether solvent containing the halogenated organomagnesium compound,
(ii) maintaining the reaction medium from step (i) at a high temperature of the order of 150° C., optionally under reduced pressure, so as to distil off the ether solvent (THF), the reaction between the tetraalkoxysilane or the trialkoxysilane and the halogenated organomagnesium compound continuing until a reaction suspension (broth) is obtained, and
(iii) filtering the suspension (reaction broth) to remove the magnesium salt contained in this suspension and to recover after distillation a trialkoxysilane or a dialkoxysilane, for example of the (cyclopentyl)₂-Si(OCH₃)₂ or (cyclohexyl)₂-Si(OCH₃)₂ type.

One of the drawbacks resulting from the use of xylene is the formation of a gel in the reaction medium, which appreciably complicates the matter and energy transfers. In particular, the gelled reaction medium obtained at the end of the reaction between the halogenated organomagnesium reagent and the tetra- or trialkoxysilane is not transferable from the reactor to the filter, even after dilution.

Moreover, the magnesium salts formed in the process according to patent application JP-A-2002179687 pose serious problems in terms of environmental management of the effluents, especially on account of the reactivity of these salts. Specifically, they react exothermically with water, releasing ethanol. What is more, these magnesium salts constitute a high pollutant charge in the effluents (very high chemical oxygen demand (COD)).

Patent application WO-A-03/027 125 describes, inter alia, a process for obtaining functionalized, in particular halogenated, organomonoalkoxysilanes, which may be used especially as synthetic intermediates. This process consists in reacting a halogenated organotrialkoxysilane with a halogenated organomagnesium compound, so as to obtain the target halogenated organomonoalkoxysilane and halogenated organomagnesium salts, according to reaction (Ra) below:

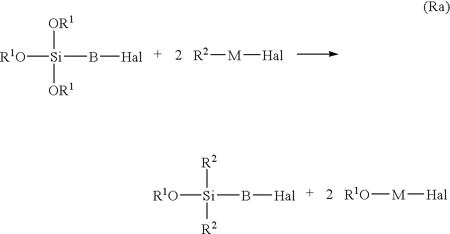

in which, for example:
the symbol R¹ is an ethyl group,
B is a divalent residue of formula —(CH₂)₃—,
the symbol Hal represents a chlorine atom,
the symbols R², which may be identical or different, each represent a —CH₃ group,
the symbol M represents magnesium.

This synthesis may be performed, for example, under conditions similar to those described in Japanese patent No. 2-178293, namely, in particular, with a halogenated organomagnesium compound dissolved in an ether solvent and with a halogenated organomagnesium compound/organotrialkoxysilane mole ratio of between 2:1 and 1:2.

The synthetic route according to patent application JP-A-2002179687 and patent application WO-A-03/027 125 is a route involving a trialkoxysilane functionalized with a haloalkyl group and a reaction mechanism of Grignard type, which involves a halomagnesium Grignard reagent, such as MeMgCl.

It is known that one of the practical problems encountered during the use of an organomagnesium Grignard reagent of the MeMgCl type lies in the difficulty that exists in preparing this reagent and in bringing it into the reaction medium. The reason for this is that the preparation of this reagent involves methyl chloride, which is a gas that is not easy to handle. In addition, to introduce the reagent into the reaction medium, it is preferable for it to be in the form of a solution. However, it turns out that this Grignard reagent is soluble in only a few solvents, or even in only one type of solvent, in particular tetrahydrofuran (THF). Furthermore, the fact that the Grignard reagent is in the form of a solution in THF introduces a constraint of dilution of the reaction medium. Finally, the dialkylalkoxy-halosilane selectivity of this synthetic route using a Grignard reagent remains largely to be improved.

Naturally, these drawbacks are also found for the preparation of organomonoalkoxy-(or monohydroxy)-silanes functionalized with a group other than a halogen group, for example an alkenyl group.

In the latter case, the lack of selectivity of the Grignard route is reflected by the production of organomonoalkoxy-(or monohydroxy)-silanes in low yields due to the presence of coproducts such as organo-bis allylsilane. The reaction also generates detrimental by-products, namely insoluble or soluble magnesium salts that are liable to constitute an obstacle to the separation and collection of the target product.

Furthermore, the presence of these coproducts and by-products of Grignard reagents (RMgX) in solution also represents a heavy environmental constraint.

Patent EP 0 798 302 describes a process for the preparation of allylsilane that comprises placing magnesium metal in contact with a mixture comprising diethylene glycol dibutyl ether, a halide (allyl chloride) and a halosilane (trimethylchlorosilane), at a temperature of between 5 and 200° C. The allylsilanes obtained are, for example, allyldimethylhydrogenosilane, allylmethylhydrogenochlorosilane, allyltrimethylsilane, allyldimethylchlorosilane and allylmethyldichlorosilane. It is never a case of them being alkoxysilanes or hydroxysilanes.

The document E. Larsson, Chem. Ber., 26 (1956) 39 Kgl. Fysiograf. Sallskop. Lund. Forh. describes the preparation of methylallyldiethoxysilane and methyldiallylethoxysilane (pages 39, 40), according to a process that consists in adding dropwise, to magnesium metal turnings wetted with ether, a mixture of methyltriethoxysilane and allyl chloride, and keeping the mixture stirring at a speed such that the reaction with the magnesium continues up to a temperature of about 60° C. Once the dropwise introduction of the mixture of methyltriethoxysilane and allyl chloride is complete, the reaction mixture is maintained at 70-80° C. for 5 hours. After cooling, a precipitate is recovered and then washed with ether. The recovered ether solution is distilled so as to collect the target products. Point 4 on page 40 of said document describes the production under these same conditions of dimethylallylethoxysilane from dimethyldiethoxysilane and allyl chloride added dropwise to magnesium turnings, irrespective of the allyl chloride/dimethyldiethoxysilane mole ratio (1:1, 2:1 or 4:1), the maximum yields of dimethylallylethoxysilane obtained being 15%, 21% and 35%. It thus appears that the selectivity towards monoallyldimethyl-monoalkoxysilane of this Larsson process is relatively low and can be improved upon. The Larsson process is based on the Barbier reaction, which is well described, for example in the Handbook of Grignard, Gary S. Silverman, Philip E. Rakita, 1996, Chapter 22, p. 405. According to this book, the Barbier reaction can be performed by adding an organohalogen reagent to a mixture of magnesium metal and of an electrophilic coreagent such as a ketone.

One of the objects of the present invention is to provide an alternative to the known synthesis of functionalized, in particular alkenylated, organomonoalkoxy-(or monohydroxy)-silanes (for example dimethylethoxyallylsilane), which are especially useful as synthetic intermediates in organic chemistry, which may preferably allow an improvement, for example in terms of production efficiency, yields, selectivity, ease of use, reduction of cost, compatibility with respect to the environment and/or availability of the consumable reagents used.

Another object of the invention is to propose a process for preparing functionalized, in particular alkenylated, organomonoalkoxy-(or monohydroxy)-silanes, which are capable of reacting with a nucleophile to produce organomonoalkoxy-(or monohydroxy)-silanes functionalized with a group other than an alkenyl functional group, for example with an amine, thiol or polysulfide functional group.

An object of the invention is also to provide novel intermediate synthetic compositions based on functionalized, in particular alkenylated, organomonoalkoxy-(or monohydroxy)-silanes, which have a reduced content of difunctional organomonoalkoxy-(or monohydroxy)-silanes.

Another object of the invention is to propose a process for preparing monofunctionalized, in particular monoalkenylated, organomonoalkoxy-(or monohydroxy)-silanes, such compounds possibly constituting a novel starting material opening new routes for obtaining organomonoalkoxy-(or monohydroxy)-silanes monofunctionalized with a group other than an alkenyl functional group, for example with a group chosen from amine, thiol and polysulfide functional groups, in particular polysulfide groups in which the polysulfide species is connected via its two ends to organomonoalkoxy-(or monohydroxy)-silane residues.

An object of the present invention is also to provide a process for preparing functionalized, in particular alkenylated, organomonoalkoxy-(or monohydroxy)-silanes, which benefits from very good selectivity towards monoallyl-diorganomonoalkoxy-(or monohydroxy)-silanes and which can be performed in a concentrated reaction medium, so as to improve the production efficiency, while avoiding the use of Grignard organomagnesium reagents, which especially pose safety constraints, in particular during storage.

Another object of the invention is to propose an alternative route to the “Grignard” route for accessing allyl-alkoxy-(or monohydroxy)-silanes.

These objects, among others, are achieved by the present invention, which relates firstly to a process for preparing at least one functionalized, in particular unsaturated, for example alkenylated, organomonoalkoxy-(or monohydroxy)-silane of formula (I):

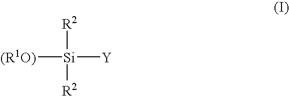

in which:
the symbol R¹ represents hydrogen or a monovalent hydrocarbon-based group chosen from a linear, branched or cyclic alkyl radical containing from 1 to carbon atoms and a linear, branched or cyclic alkoxyalkyl radical containing from 1 to 20 carbon atoms;
the symbols R², which may be identical or different, each represent a linear, branched or cyclic alkyl radical containing from 1 to 8 carbon atoms; an aryl radical containing from 6 to 18 carbon atoms; an arylalkyl radical or an alkylaryl radical (C₆-C₁₈ aryl, C₁-C₆ alkyl); R² optionally bearing at least one halogenated or perhalogenated group;
the symbol Y represents a monovalent organic functional group, preferably chosen from the “sensitive” functional groups R³, comprising at least one ethylenic and/or acetylenic unsaturation, in particular selected from:
   linear, branched or cyclic alkenyl groups R^{3.1} containing from 2 to 10 carbon atoms,
   linear, branched or cyclic alkynyl groups R^{3.2} containing from 2 to 10 carbon atoms,
   linear, branched or cyclic -(alkenyl-alkynyl) or-(alkynyl-alkenyl) groups R^{3.3} containing from 5 to 20 carbon atoms,
the radicals R^{3.1} being particularly preferred, and Y also possibly comprising at least one heteroatom and/or bearing one or more aromatic groups;
this process being characterized
   in that it consists essentially in reacting at least one organoalkoxysilane (II), chosen from di-, tri- and tetraalkoxysilanes and mixtures thereof, with at least one halogenated organic compound (III) (preferably an allyl halide), in the presence of at least one metal (M) and in the presence of at least one solvent (S1), this halogenated organic compound (III) being capable of substituting the alkoxy radicals with organic radicals, according to the following reaction scheme (reaction II/III):

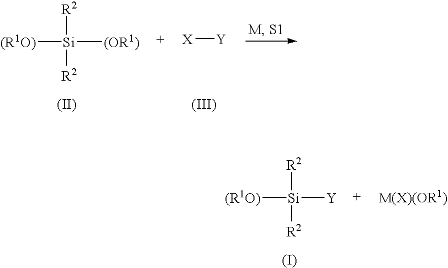

in which:
the symbols R¹, R² and Y are as defined above, the symbol M corresponds to a metal chosen from the group comprising Mg, Na, Li, Ca, Ba, Cd, Zn, Cu, mixtures thereof and alloys thereof (preferably, M is magnesium), the symbol X represents a halogen (symbol Hal), preferably a chlorine, bromine or iodine atom,
and in that it comprises the following steps:
-a- placing the metal M and the solvent S1, or even optionally a solvent S2, in contact;
-b- optionally activating the reaction, preferably by adding a catalytic amount of at least one halogen and/or an alkyl halide and/or by heating the reaction medium and/or the metal M;
-c- adding the organoalkoxysilane (II);
-d- adding the halogenated organic compound (III), gradually and at a rate of introduction into the reaction medium lower than or equal to the rate of consumption of (III) in the reaction (II/III);
-e- reaction (II/III) leading to the production of the reaction product (I); the temperature of the reaction medium preferably being maintained at a temperature θr less than or equal to the boiling point θb.p.S1 of the solvent S1;
-f- optionally adding a solvent S2;
-g- separating out and collecting a functionalized organomonoalkoxy-(or monohydroxy)-silane (I), preferably by distillation, and even more preferentially by distillation under reduced pressure;
-h- optionally filtering and optionally washing the filter cake obtained, or
-h′- optionally dissolving the metal salts, preferably by washing using an acidic aqueous solution;
-i- optional hydrolysis step for converting the organomonoalkoxysilane (I) into an organomonosilanol (I).

For the purposes of the invention, the boiling point “θb.p.” of a compound corresponds to its initial boiling point, according to the standardized test ASTM D 86-99.

One of the essential steps of the process according to the invention is step -d- of gradual and controlled introduction of a halogenated organic compound (III) into the reaction medium.

Unexpectedly, and after considerable research, the inventors have in fact revealed that the introduction of the halogenated organic compound (III), for example the allyl halide, is preferably slower than the consumption of said compound (III) in the reaction. In general, compound (III) is in liquid form, and this introduction is then referred to as running of the liquid (III) into the reaction medium. This introduction rate may be controlled by any suitable means. It is thus possible, given that the reaction is exothermic, to choose the temperature as the physical parameter reflecting the amount of compound (III) added to the reaction medium. One alternative, which may or may not be combined with measuring the reaction temperature, consists in measuring the concentration of compound (III) in the reaction medium, preferably continuously or semi-continuously, and by any suitable means known to those skilled in the art. It may be a matter, for example, of gas chromatography.

The gradual introduction of compound (III) into the reaction medium allows the reaction exothermicity to be controlled.

According to one advantageous characteristic of the invention, during step -d-, the halogenated organic compound (III) is introduced into the reaction medium in an equivalent molar amount, or even in slight excess or in slight deficit, relative to the starting alkoxysilane (II). For the purposes of the invention, the term “slight” deficit or excess means, for example, a margin of ±5 mol %.

The process according to the present invention may thus make it possible to recover the target functionalized (preferably alkenylated) organomonoalkoxy-(or monohydroxy)-silane in a selective, efficient, simple, direct, economical and industrial manner, without excessive constraints in terms of ecotoxicity (treatment of the effluents). The by-products such as the metal salts (for example magnesium salts) are formed in smaller amounts than those observed in the known routes, especially the Grignard route. The process according to the invention is advantageously “eco-compatible”.

In addition, the use of the metal (M), preferably magnesium, in metallic form makes it possible to reduce the consumption of metal and above all constitutes an advantageous alternative compared with the use of a Grignard reagent RMgX in solution, which is difficult to prepare and to store.

The performance in terms of selectivity of the process of the invention is reflected in the yield and the production efficiency, inter alia.

For similar stoichiometric conditions, the gains in yield for obtaining compound (I) are, advantageously, at least 150% compared with the known Larsson technique according to which methyltriethoxysilane and allyl chloride are added together to the reaction mixture containing the magnesium metal turnings.

According to the process of the invention, it is possible to isolate the silane in an isolated degree of conversion of at least 65%, in particular of at least 70%, or even of at least 75% or even 85%, and a purity of greater than or equal to 95%, and above all with a very high selectivity, especially of at least 98%: for example, a single allylation is involved when Y is an allyl. In addition, the amount of Si—O—Si oligomers formed is very low, for example less than 1 mol %.

This process consists, inter alia, in slowly introducing compound (III), for example the allyl halide, to a stock containing the organoalkoxysilane siliceous derivative (II) and the metal (M), in particular magnesium, for example in the form of turnings.

For example, the mole ratios of these reagents (III), (II) and metal (N), especially magnesium, are stoichiometric. It is also possible to use an excess of metal (especially magnesium) to further limit the formation of bis-allyl.

In formula (I) above, the preferred radicals R¹ are chosen from the following radicals: methyl, ethyl, n-propyl, isopropyl, n-butyl, CH₃OCH₂—, CH₃OCH₂CH₂— and CH₃OCH(CH₃)CH₂—; more preferably, the radicals R¹ are chosen from methyl, ethyl, n-propyl and isopropyl, ethyl being particularly preferred.

The preferred radicals R² are chosen from the following radicals: methyl, ethyl, n-propyl, isopropyl, n-butyl, n-hexyl and phenyl; more preferably, the radicals R² are methyls.

Preferably, in the functionalized, in particular alkenylated, organomonoalkoxy-(or monohydroxy)-silanes corresponding to formula (I), the radical Y may represent:

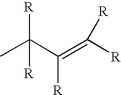

the symbol R representing identical or different radicals and corresponding to hydrogen or to a linear, branched or cyclic alkyl containing from 1 to 8 carbon atoms, preferably —CH₃ or —CH₂CH₃.

In accordance with one preferred embodiment of the invention, at least one of the following definitions (preferably all the following definitions) is (are) satisfied in formulae (I), (II) and (III)
the symbols R¹ and R², which may be identical or different, each represent hydrogen, CH₃CH₂— or CH₃— (preferably, R¹ represents CH₃CH₂— and R² represents CH₃—);
the symbol M represents Mg;
the symbol X represents Cl or Br;
the symbol Y corresponds to an allyl or cyclohexene residue.

The choice of the solvent S1, and optionally of the solvent S2, is generally an important parameter of the process according to the invention.

Thus, S1 may be chosen, for example, from the group of solvents having a boiling point θb.p.1 below the boiling point θb.p.(I) of compound (I).

S1 may be chosen from the group of solvents having a boiling point θb.p.S1 generally below 150° C. (at 760 mmHg), for example below 126° C. (at 760 mmHg).

Preferably, S1 is chosen from the group of ether organic solvents and/or from the group of acetals, and even more preferentially from the subgroup comprising tetrahydrofuran (THF), methyl-THF (Me-THF), dialkyl ethers (preferably diethyl ether or, even more preferably, dibutyl ether), and dioxanes, and mixtures thereof.

The use of S2 corresponds especially to the optional step -f- and has the purpose of containing in solid or dissolved form any metal salts (in particular magnesium salts) liable to be formed in the reaction medium. S2 is directed towards enabling easier separation and collection of the target compound (I) during step -g-, i.e., preferably, distillation and even more preferentially distillation under reduced pressure. Advantageously, S2 does not react with the possible metal salts (for example magnesium salts). Preferably, S2 is different than S1.

S2 is preferentially chosen from the group of solvents having a boiling point θb.p.S2 above the boiling point θb.p.(I) of the organomonoalkoxy-(or monohydroxy)-silane (I), and advantageously above the boiling point θb.p.S1 of the solvent S1.

Specifically, it is generally practical for S2 to be heavy enough to be the last agent to distil off relative to compound (I) and to the solvent S1.

As solvent S2, examples of preferred solvents may be chosen from the group of solvents having a boiling point θb.p.S2 above 126° C. (at 760 mmHg), in general of at least 150° C. (at 760 mmHg), and especially from the group of solvents defined as follows: 150° C.≦θb.p.S2, preferably 180° C.≦θb.p.S2 and even more preferentially 190° C.≦θb.p.S2≦350° C. (at 760 mmHg).

In practice and for illustrative purposes, S2 may be chosen from the group of solvents comprising hydrocarbons, hydrocarbon fractions, (poly)aromatic compounds (especially alkylbenzenes), alkanes (in particular heavy alkanes), (poly)ethers, phosphorus compounds, sulfolanes (especially dialkyl sulfones), ionic liquids and dialkyl nitriles, and mixtures thereof.

S2 may be chosen from methylal, anisole and diphenyl ether.

As examples of commercial products that may be suitable for use as solvents S2, mention may be made of petroleum fractions or hydrocarbon fractions, and in particular those sold under the name Isopar® M, N or P, by the company Exxon Mobil Chemical, or alternatively alkylbenzene.

According to one variant of the invention, the optional addition of S2 to the reaction medium, at the start of the process, for example with S1, in particular during step -a-, and/or during the optional step -f-, is advantageously combined not only with a step -g- of separating out and collecting a functionalized organomonoalkoxy-(or monohydroxy)-silane (I), preferably by distillation and even more preferentially by distillation under reduced pressure, but also with the optional step -h′- that advantageously takes place after step -g- and that consists in dissolving the metal salts (for example the magnesium salts) present in solid form (for example in suspension) in the reaction medium, this dissolution preferably being performed by adding an acidic aqueous solution. The metal salts (for example magnesium salts) thus dissolved form by-products that are relatively easy to manage environmentally.

It may be envisioned, in accordance with the invention, that the optional addition of S2 be performed not only during step -a- and/or during the optional step -f-, but also at any point in the process, preferably before and/or during step -g-, at least once.

In general, in quantitative terms, the solvent S1 is used such that the S1/M mole ratio is between 3:1 and 1:1, preferably between 2.5:1 and 1.5:1 and even more preferentially about 2:1.

The amount of solvent S2 used in the reaction medium may be, for example, between 50 and 300 g per 300 g of reaction medium before step -h- of separating out and collecting compound (I).

One of the preferred characteristics of the process according to the invention involves the control of the temperature of the reaction medium θr. In general, θr may depend on the operating conditions of the process, in particular on the type of addition of the halogenated organic compound (III).

The temperature θr may be, for example, between about (θb.p.S1−(θb.p.S1×0.50)) and θb.p.S1, especially between about (θb.p.S1−(θb.p.S1×0.20)) and θb.p.S1.

Examples of temperature ranges for Or depending on the nature of the solvent S1 are given below in a nonlimiting manner:
diethyl ether: 30° C.≦θr≦40° C.
THF: 30° C.≦θr≦65° C.
dibutyl ether: 100° C.≦θr≦140° C.

According to one preferred embodiment, the halogenated organic compound (III) is a haloalkenyl, preferably a cyclic or acyclic allyl or methallyl, isopentyl, butenyl or hexenyl halide (especially chloride or bromide), and even more preferentially an allyl chloride or bromide.

According to one particularly interesting characteristic of the invention, step -h- of separating out and collecting compound (I) is performed in batch mode at least once, preferably by distillation under pressure.

To improve upon the performance of the process of the invention, especially as regards the selectivity, it is advantageous to use an M/(II) mole ratio of between 1.4:1 and 1:1, preferably between 1.3:1 and 1.1:1 and even more preferentially equal to about 1.2:1.

Possibilities of implementation of steps -a- to -i- are detailed hereinbelow.

In practice, the reaction pressure is, for example, the ambient atmospheric pressure.

### Step -a-

Advantageously, the placing of the metal M, for example magnesium, in contact with the solvent 51, for example anhydrous ether, may consist in placing metal turnings, chips or the like in a reactor and then adding the solvent S1, or even optionally a solvent S2, thereto.

### Step -b-

This optional activation may be chemical of catalytic type, by adding a catalytic amount of at least one halogen and/or of an alkyl halide. For example, the halogen (X′) optionally introduced is an iodine crystal or seed optionally accompanied by a solvent such as 1,2-dibromoethane or any other haloalkane.

This chemical activation of catalytic type may be complemented or replaced with a thermal activation of the metal M, which consists, for example, in simply leaving said metal M for several minutes at an activation temperature close to the temperature θr of the reaction medium.

An indicator of the end of the activation period may advantageously be decolorization of the reaction medium.

### Step -c-

The organoalkoxysilane (II) is added to the reaction medium without any particular precautions.

According to one variant, the organoalkoxysilane (II), for example the dialkoxydialkylsilane in which R1 represents ethyl and R2 represents methyl, may be added before the introduction of the halogen X′.

### Step -d-

The halogenated organic compound (III), preferably the allyl halide, is introduced slowly into the reaction medium, which is maintained at a temperature θr, corresponding, for example, to about 80% of the boiling point θb.p. of the solvent S1. In practice, this may be, for example, about 30° C. when S1 is diethyl ether and about 50° C. when 51 is tetrahydrofuran.

### Step -e-

The reaction (II/III) may proceed for several hours at a temperature θr, for example for 1 to 36 hours and preferably for 1 to 24 hours.

As the reaction is exothermic, control of the temperature of the reaction medium is performed via the rate of introduction of the halogenated organic compound (III) and also by any known and suitable temperature maintenance means (for example by using a refrigerating reaction chamber).

### Step -f-

The optional addition of solvent S2 is performed in a conventional manner without any particular precautions. In general, the amount of solvent S2 used is such that the reaction medium can be easily stirred and/or transferred from one place to another.

### Step -g-

Distillation is one of the suitable methods among others for selectively isolating the organomonoalkoxy-(or monohydroxy)-silane (I) from the reaction medium. To this end, preferably, it is important for θb.p.S2 to be higher than θb.p.(I) when S2 is used.

In practice, this distillation may be performed at a temperature of between 40 and 120° C. and preferably between 70 and 90° C., at a reduced pressure of between 1 and 50 millibar and preferably between 10 and 30 millibar.

### Step -h-

In the case especially where a precipitate or an insoluble reaction mass forms in the reaction medium, it is then generally practical to filter the reaction medium, and then optionally to wash the filter cake obtained, according to standard techniques.

By way of example, the filter used may be a glass sinter, a metal gauze filter, a band filter, etc.

The solvent used for washing the cake is advantageously S1 and/or S2.

Step -h′-

This optional step of dissolution of the metal salts (for example the magnesium salts) is an alternative to step -h-. Step -h′-, just like step -h, preferably takes place after a distillation -g- of the target functionalized organomonoalkoxy-(or monohydroxy)-silane (I). It is preferably performed using an acidic aqueous solution, for example based on at least one strong acid (especially a mineral acid), such as HCl, in particular so as to bring the pH of the reaction medium to a pH advantageously equal to about 4.0-4.5.

### Step -i-

This optional hydrolysis step is preferentially performed via rapid or gradual addition of a hydrolysis agent, preferably water, or, according to a variant, of a solution, in particular an aqueous-organic solution, for example a solution buffered at a pH of between 4.5 and 8 and in a stoichiometry such that there are 1 to 2 equivalents (for example 1.5 equivalents) of water per equivalent of organomonoalkoxy-(or monohydroxy)-silane.

According to one preferred mode of the invention, the hydrolysis temperature is between 40 and 90° C. and in particular between 50 and 90° C., for example between 70 and 80° C.

Advantageously, in the process according to the invention, the metal salts (optionally halogenated) that are formed after the reaction have the appreciable advantage of being insoluble in the reaction medium, such that they can be easily and efficiently separated therefrom, without constituting an excessive pollutant charge (low COD).

In variant -h′-, the removal of the metal salts is even easier, since they are in the form of an aqueous solution.

One of the essential points of the process of the invention is that of proposing a slow introduction of compound (III) into the reaction medium, such that this medium always has a low, or even zero, concentration of Grignard reagent and also of compound (III) (in particular allyl halide).

Another important factor of said process lies in the moment of introduction of compound (III), which is subsequent to the incorporation into the reaction medium of compound (II), of the solid metal M, of the solvent S1 and of the optional halogen X′ (or of the optional alkyl halide).

According to the invention, the reaction medium advantageously does not comprise any solid Grignard reagent and is therefore free of constraints associated with the reaction mechanism of Grignard type (especially the problem of storage).

The process according to the invention may comprise continuous sequences, but it is preferably semi-continuous.

In accordance with the invention, the product (I) obtained after the process described above is a synthetic intermediate, which is especially capable of reacting with at least one nucleophile for the production of other organoalkoxysilanes functionalized with groups Y other than the groups R³, in particular with groups other than alkenyls, for example amine, thiol or polysulfide functional groups.

The nucleophile, with which the synthetic intermediate (I) is capable of reacting, for the production of these organoalkoxysilanes functionalized with groups Y other than the groups R³, may be of diverse nature. In particular, it may be a nucleophile of the type described in patent application WO-A-03/027 125 (page 12, line 10 to page 14, line 27).

For further details regarding the implementation of the abovementioned synthesis, reference may be made to the content of patent application EP-A-0 848 006, which illustrates, with other reagents, procedures that may be applied for performing the synthesis under consideration.

The present invention also concerns a composition (synthetic intermediate composition) comprising:
an effective amount of at least one organomonoalkoxy-(or monohydroxy)-silane of formula (I) (directly) obtained via the process according to the invention:

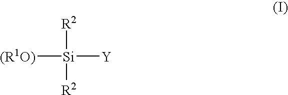

R¹, R² and Y being as defined above;
and not more than 5%, preferably not more than 1% and even more preferentially not more than 0.5% by weight of:

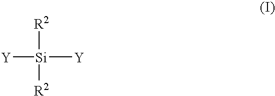

R² and Y being as defined above.

Preferably, in this composition, the symbols R¹ and R², which may be identical or different, each represent CH₃CH₂— or CH₃— (more preferably, R¹ represents CH₃CH₂— and R² represents CH₃—) and the symbol Y represents a group R³, more preferably an alkenyl group and even more preferentially an allyl or methallyl group.

The examples that follow illustrate the invention without, however, limiting its scope.

### EXAMPLES

### Example 1

1.00 g (41.1 mmol) of Mg turnings, 20 ml of anhydrous ether and 0.2 ml (2.3 mmol) of 1,2-dibromoethane are placed in a 100 ml three-necked reactor under argon. A solution of 5.00 g (40.96 mmol) of allyl bromide in 20 ml of anhydrous ether is added slowly over 2 hours. The temperature is maintained at 40° C. Disappearance of the Mg and of the allyl bromide is observed. 20 ml of anhydrous ether and 6.30 g (41.25 mmol) of dimethyldiethoxysilane are placed in a second reactor, under nitrogen. The solution from the first reactor is then introduced slowly therein. The temperature is maintained at about 30-35° C. A white precipitate forms. The mixture is left to react for 72 hours. The resulting mixture is then filtered under nitrogen and the filter cake is washed with anhydrous ether. The ether solution is evaporated. A liquid exclusively containing allyldimethylethoxysilane is obtained. The yield after isolation by distillation is about 40% (boiling point: 126° C. at 760 mmHg). The amount of bisallyldimethylsilane is less than 1 mol %. NMR, IR, Raman and SP mass analyses confirm the following structure of the product obtained:

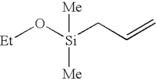

### Example 2

11 ml of anhydrous THF, 2.034 g (82.88 mmol) of Mg turnings, an iodine seed and 6.30 g (41.25 mmol) of dimethyldiethoxysilane are placed in a 100 ml reactor under argon. 4.020 g (54.42 mmol) of allyl chloride are then added slowly. The mixture is left to react for 6 hours at room temperature. The degree of conversion of the dimethyldiethoxysilane is total. 10 ml of diisopropylbenzene (mixture of isomers) are then added and the reaction mass is distilled directly. The allyldimethylethoxysilane is obtained in a yield of 72%. The amount of bisallyldimethylsilane is less than 1 mol %.

### Example 3

18 ml of anhydrous ether, 2.25 g (92.46 mmol) of Mg turnings and an iodine seed are placed in a 100 ml reactor under argon. 12.60 g (82.44 mmol) of dimethyldiethoxysilane are then added, and 8.28 g (107.12 mmol) of allyl chloride are run in slowly. The mixture is left to react for 21 hours at room temperature. 60 ml of Isopar M are then added. The resulting mixture is filtered under nitrogen and, by distilling the reaction mass, 8.50 g of allyldimethylethoxysilane are recovered in a yield of 73%. The amount of bisallyldimethylsilane is less than 1 mol %.

### Example 4

3.65 g (150 mmol) of Mg turnings, 15 ml of anhydrous ether, an iodine crystal and 100 μl of 1,2-dibromoethane are placed in a 100 ml three-necked flask under argon. 5.49 g (36 mmol) of dimethyldiethoxysilane are added, and a solution of 3.63 g (29.7 mmol) of allyl bromide in 18 ml of anhydrous ether is then run in slowly. The reaction is maintained at about 39-40° C. for 18 hours. The reaction mass is cooled to room temperature and 20 ml of ethanol are added thereto. After filtration, the filtrate is distilled under vacuum. Pure allyldimethylethoxysilane is thus recovered.

### Example 5

1.04 g (42.7 mmol) of Mg turnings and 8 ml of anhydrous ether are placed in a 100 ml three-necked flask under argon. 4.4 ml of dichlorodimethylsilane (36.2 mmol) and an iodine seed are then added. 3.9 ml (47.7 mmol) of allyl chloride are then added. The reaction is exothermic. The temperature is maintained at about 40° C. for 40 minutes. It is then maintained for 24 hours at room temperature. The reaction mass is treated with 20 ml of ethanol and 20 ml of triethylamine. The reaction mass is filtered and the filtrate is taken up in 50 ml of ether. The organic phase is washed with saturated NH₄Cl solution, dried and then distilled under vacuum. The allyldimethylethoxysilane is thus obtained in a yield of about 50%. The amount of bisallyl-dimethylsilane is about 20 mol %.

### Example 6

51.9 g (2.13 mol) of Mg turnings and 300 ml of anhydrous ether are placed in a 1 liter three-necked flask under argon. 126 ml (0.71 mol) of dimethyldiethoxysilane are then added. Next, 500 μl of 1,2-dibromoethane and an iodine crystal are introduced. 86 ml (1.04 mol) of allyl chloride are added slowly, via a dropping funnel. The reaction is exothermic, and the temperature of the reaction mass is maintained at about 35-40° C. during the addition. The mixture is left for 2 hours at room temperature. The reaction mass is then filtered and the cake is washed with three times 100 ml of anhydrous ether. The filtrate is then distilled under vacuum. 82.6 g of allyldimethyl-ethoxysilane are obtained in a yield of 76%. The amount of bisallyldimethylsilane is less than 1 mol %.

### Example 7

2.47 g of Mg turnings (1.2 eq.), 80 ml of dry diethylene glycol dibutyl ether and one iodine seed are placed in a rigorously anhydrous 250 ml three-necked flask, with a temperature probe, a magnetic stirrer, an oil bath and a condenser, and under argon. The Mg is left to activate for 20 minutes at 100° C. Once the reaction mass has decolorized, and still at 100° C., 400 μl of dibromoethane are added until cloudiness appears in the reaction mass. 14.6 ml of diethoxydimethylsilane are then added. 13.4 ml of allyl chloride (2.0 eq.) are then run in slowly, while maintaining the temperature of the reaction mass at 110° C. After distillation, the isolated yield of allyldimethylethoxysilane is about 55% without formation of bisallyldimethylsilane.

### Example 8

2.47 g of Mg turnings (1.2 eq.), 80 ml of dry anisole and one iodine seed are placed in a rigorously anhydrous 250 ml three-necked flask, with a temperature probe, a magnetic stirrer, an oil bath and a condenser, and under argon. The Mg is left to activate for 20 minutes at 100° C. Once the reaction mass has decolorized, and still at 100° C., 150 μl of dibromoethane are added until cloudiness appears in the reaction mass. 14.6 ml of diethoxydimethylsilane are then added. 12.2 ml of allyl chloride (1.8 eq.) are then run in slowly, while maintaining the temperature of the reaction mass at 110° C. After distillation, the isolated yield of allyldimethylethoxysilane is about 65% without formation of bisallyldimethylsilane.

### Example 9

36.98 g of Mg turnings (1.3 eq.), 1.2 liters of dry dibutyl ether and 250 mg of iodine are placed in a rigorously anhydrous 2 liter three-necked flask, with a temperature probe, a magnetic stirrer, an oil bath and a condenser, and under argon. The Mg is left to activate for 45 minutes at 115° C. Once the reaction mass has decolorized, and still at 115° C., 3 ml of dibromoethane are added until cloudiness appears in the reaction mass. 219 ml of diethoxydimethylsilane are then added. 163 ml of allyl chloride (1.6 eq.) are then run in slowly (10 ml/hour), while maintaining the temperature of the reaction mass at 115° C. A degree of conversion of greater than 95% is obtained after 24 hours of reaction. The reaction mass is then distilled at 760 mmHg, using a 30 cm packed column, with retrogradation and a degree of reflux of 1/10. After distillation, the isolated yield of allyldimethylethoxysilane is about 71%, without formation of bisallyldimethylsilane.

### Example 10

35 g of Mg turnings (1.53 eq.), 198.5 g of anhydrous dibutyl ether and 70 mg of iodine are placed in a 1 liter jacketed reactor, inertized with nitrogen, with a temperature probe and a mechanical stirrer. The Mg is left to activate at 130° C. Once the reaction mass has decolorized, and still at 130° C., 140 g of diethoxydimethylsilane are added. 88 g of allyl chloride (1.22 eq.) diluted in 212 g of anhydrous dibutyl ether are then run in slowly (duration of about 5.5 hours). The reaction medium is maintained at 130° C. for 16 hours; a degree of conversion of greater than 95% is obtained. The reaction mass is then distilled under reduced pressure (minimum pressure: 350 mbar), using a 60 cm packed column, with retrogradation and a degree of reflux of 1/10. After distillation, the isolated yield of allyldimethylethoxysilane is 79%, without formation of bisallyldimethylsilane.

### Example 11

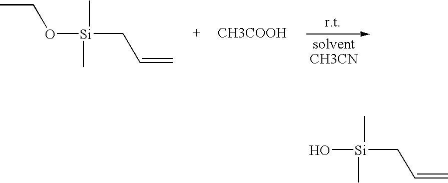

The following are placed in a 100 ml one-necked flask:
2.0 g (13 mmol, 1 eq.) of allylethoxydimethylsilane,
20 ml of CH₃CN,
20 ml of 2M acetic acid (4 mmol, 3.1 eq.).

The mixture is stirred at room temperature for 26 hours.

It is extracted with twice 40 ml of diethyl ether, and the organic phases are combined.

The organic phase thus obtained is washed with seven times 30 ml of water.

The organic phase is dried over MgSO₄.

The resulting organic phase is filtered through a No. 4 sinter funnel.

The filtrate is evaporated on a rotary evaporator (30° C., pressure of 25 mbar).

A clear, mobile yellow liquid is obtained in a mass m of 1.37 g, and a yield of 91%.

The structural analysis indicates that the liquid obtained predominantly contains the product having the following structure:

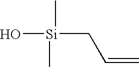

1.-17. (canceled)

18. A process for preparing at least one functionalized organomonoalkoxy-(or monohydroxy)-silane of formula (I): 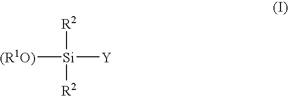
in which:
the symbol R¹ is hydrogen or a monovalent hydrocarbon-based group selected from among a linear, branched or cyclic alkyl radical having from 1 to 20 carbon atoms and a linear, branched or cyclic alkoxyalkyl radical having from 1 to 20 carbon atoms;
the symbols R², which may be identical or different, are each a linear, branched or cyclic alkyl radical having from 1 to 8 carbon atoms, an aryl radical having from 6 to 18 carbon atoms, an arylalkyl radical or an alkylaryl radical (C₆-C₁₈ aryl, C₁-C₆ alkyl); R² optionally bearing at least one halogenated or perhalogenated substituent;
the symbol Y is a monovalent organic functional group, a functional group R³ comprising at least one site of ethylenic and/or acetylenic unsaturation, or is selected from among:
linear, branched or cyclic alkenyl groups R^{3.1} having from 2 to 10 carbon atoms,
linear, branched or cyclic alkynyl groups R^{3.2} having from 2 to 10 carbon atoms,
linear, branched or cyclic -(alkenyl-alkynyl) or -(alkynyl-alkenyl) groups R^{3.3} having from 5 to 20 carbon atoms,
wherein Y optionally comprises at least one heteroatom and/or bears one or more aromatic substituents;
which process comprises:
reacting at least one organoalkoxysilane (II), selected from among di-, tri- and tetraalkoxysilanes and mixtures thereof, with at least one halogenated organic compound (III) in the presence of at least one metal (M) and in the presence of at least one solvent (S1), said halogenated organic compound (III) being suited for substituting the alkoxy radicals with organic radicals, according to the following reaction scheme (reaction II/III): 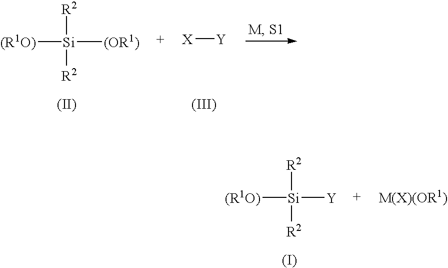
in which:
the symbols R¹, R² and Y are as defined above;
the symbol M is a metal selected from among Mg, Na, Li, Ca, Ba, Cd, Zn, Cu, mixtures thereof and alloys thereof:
the symbol X is a halogen;
and comprising the following steps:
(a) contacting the metal M with the solvent S1, or optionally with a solvent S2;
(b) optionally activating the reaction, whether by adding a catalytic amount of at least one halogen and/or an alkyl halide and/or by heating the reaction medium and/or the metal M;
(c) adding the organoalkoxysilane (II) thereto;
(d) adding thereto the halogenated organic compound (III), gradually and at a rate of introduction into the reaction medium lower than or equal to the rate of consumption of (III) in the reaction (II/III);
(e) wherein the reaction (II/III) producing the reaction product (I), the temperature of the reaction medium optionally being maintained at a temperature θr less than or equal to the boiling point θb.p.S1 of the solvent S1;
(f) optionally adding a solvent S2;
(g) separating out and recovering a functionalized organomonoalkoxy-(or monohydroxy)-silane (I);
(h) optionally filtering and optionally washing the filter cake thus obtained, or
(h′) optionally dissolving the metal salts by washing with an acidic aqueous solution; and
(i) optionally hydrolyzing the organomonoalkoxysilane (I) into an organomonohydroxysilane (I).

19. The process as defined by claim 18, wherein the radicals R¹ are selected from among the following radicals: methyl, ethyl, n-propyl, isopropyl, n-butyl, CH₃OCH₂—, CH₃OCH₂CH₂— and CH₃OCH(CH₃)CH₂—;
the radicals R² are selected from among the following radicals: methyl, ethyl, n-propyl, isopropyl, n-butyl, n-hexyl and phenyl; and
the radical Y is: 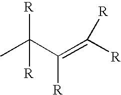
wherein the symbols R, which may be identical or different, are each hydrogen or a linear, branched or cyclic alkyl radical having from 1 to 8 carbon atoms.

20. The process as defined by claim 18, wherein step (d), the halogenated organic compound (III) is introduced into the reaction medium in an equivalent molar amount relative to the alkoxysilane (II).

21. The process as defined by claim 18, wherein S1 is selected from among solvents having a boiling point θb.p.S1 below the boiling point θb.p.(I) of compound (I).

22. The process as defined by claim 18, wherein S1 is a solvent having a boiling point θb.p.S1 below 150° C. (at 760 mmHg).

23. The process as defined by claim 18, wherein S1 is selected from among ether organic solvents and/or from acetals, or from tetrahydrofuran (THF), methyl-THF (Me-THF), dialkyl ethers, dioxanes, and mixtures thereof.

24. The process as defined by claim 18, including S2 selected from among solvents having a boiling point θb.p.S2 above the boiling point θb.p.(I) of compound (I) and optionally above the boiling point θb.p.S1 of solvent S1.

25. The process as defined by claim 18, including S2 comprising a solvent with a boiling point θb.p.S2 above 126° C. (at 760 mmHg), optionally of at least 150° C. (at 760 mmHg).

26. The process as defined by claim 18, including S2 selected from among solvents comprising hydrocarbons, hydrocarbon fractions, (poly)aromatic compounds, alkanes, (poly)ethers, phosphorus compounds, sulfolanes, ionic liquids and dialkyl nitriles, and mixtures thereof.

27. The process as defined by claim 18, wherein the temperature θr ranges from about (θb.p.S1−(θb.p.S1×0.20)) and θb.p.S1, optionally from about (θb.p.S1−(θb.p.S1×0.20)) and θb.p.S1.

28. The process as defined by claim 18, wherein S1 comprises:
diethyl ether with 30° C.≦θr≦40° C.
THF with 30° C.≦θr≦65° C.
dibutyl ether with 100° C.≦θr≦140° C.

29. The process as defined by claim 18, wherein the step (g) of separating out and recovering (I) is performed in batch mode at least once, optionally by distillation under reduced pressure.

30. The process as defined by claim 18, wherein the halogenated organic compound (III) is a haloalkenyl, a cyclic or acyclic allyl or methallyl, isopentyl, butenyl or hexenyl halide, optionally an allyl chloride or bromide.

31. The process as defined by claim 18, wherein the S1/M mole ratio ranges from 3:1 to 1:1.

32. The process as defined by claim 18, wherein the M/(II) mole ratio ranges from 1.4:1 to 1:1.

33. A composition comprising:
an amount of at least one organomonoalkoxy-(or monohydroxy)-silane of formula (I) directly obtained via the process as defined by claim 18: 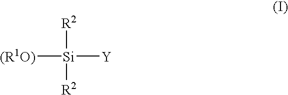
and not more than 5% of:

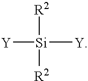

34. The composition as defined by claim 33, wherein the symbols R¹ and R², which may be identical or different, are each CH₃CH₂— or CH₃—, R¹ optionally being CH₃CH₂— and R² optionally being CH₃—; and the symbol Y is a group R³, optionally an alkenyl group.
